(19) United States
(12) Patent Application Publication
(10) Pub. No.: US 2008/0313334 A1
(43) Pub. Date: Dec. 18, 2008

(54) DATA EXCHANGE PROTOCOL ENHANCEMENT TO QUERY OBJECT PERMISSIONS

(75) Inventors: Frank Willuns, Voerde (DE); Mikko Suomela, Vesilahti (FI)

Correspondence Address: FOLEY & LARDNER LLP, P.O. BOX 80278, SAN DIEGO, CA, 92138-0278, US

(73) Assignee: Nokia Corporation

(21) Appl. No.: 11/764,741

(22) Filed: Jun. 18, 2007

(51) Int. Cl. G06F 15/16

(52) U.S. Cl. 709/227

(57) ABSTRACT

Systems and methods are provided to view the properties/attributes of a selected or specified object in the Object Exchange (OBEX) environment. A field, e.g., a Permissions field, is included in a GET request, where the field includes a header portion, e.g., a Permission header set to an arbitrary value.

In responding to the GET request from an OBEX client, an OBEX server includes one or more permissions associated with an object specified in the GET request in a response, where the one or more associated permissions are included before actual body data. Therefore, the OBEX client may efficiently and directly query an object's attributes. Additionally, if the OBEX client is not interested in the body data of the object, the GET operation can be aborted upon receiving the desired Permission header.

### FIELD OF THE INVENTION

The present invention relates generally to systems and methods of querying object attributes over a data exchange protocol. More particularly, the present invention relates to a specialized operation for the direct querying of an object's attributes.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

OBEX refers to a communication protocol that is conventionally utilized for exchanging binary objects between devices, where objects can be an arbitrary “thing” or some data entity. OBEX was first developed by the Infrared Data Association (IrDA) which is a group that defines physical specifications communications protocol standards for exchanging data over infrared light in a short-range environment, e.g., personal area networks (PANs). Because of the simplicity and efficiency of OBEX, the protocol has also been adopted by the Bluetooth Special Interest Group and the SyncML group of the Open Mobile Alliance (OMA). Therefore, OBEX is not limited to uses within IrDA environments, and can be utilized to exchange data/objects between personal computers, personal digital assistants, mobile devices, printers, cameras, kiosks, home electronics, etc. As noted above, objects can comprise many types of data entities, e.g., files, electronic business cards, bank account balances, etc.

The functions performed over OBEX are similar to those utilized with Hypertext Transfer Protocol (HTTP), e.g. a client (device) can use a reliable transport to connect to a server (e.g., another device) and request or provide objects. One difference between OBEX and HTTP, however, is that OBEX can be employed in and between devices that do not have the requisite resources necessary to function as an HTTP server, such as those described above. Moreover, OBEX can target devices that comprise usage models which are different from those that conventionally access and/or utilize the World Wide Web over HTTP. Additionally, while HTTP is conventionally layered above a Transmission Control Protocol (TCP)/Internet Protocol (IP) port, OBEX is conventionally implemented over an Ir Link Access Protocol (IrLAP)/Ir Link Management Protocol (IrLMP)/Tiny Transport Protocol (TinyTP) stack on an IrDA device. With regard to Bluetooth, OBEX can be implemented above a Baseband/Link Manager/Logic Link Control and Adaptation Protocol (L2CAP)/Radio Frequency Communication (RFCOMM) stack. It should be noted that other “bindings” of OBEX are possible.

Furthermore, while HTTP uses human-readable text, OBEX utilizes binary-formatted type-length-value triplets, referred to as “headers” to exchange information regarding a request or object. These headers are more easily parsed with devices, such as those described above, that have limited resources and/or processing capabilities. Further still, a single transport connection over OBEX can comprise a plurality of related processes, whereas transactions over HTTP involve single-request connections which are closed upon receiving a response to the single request.

Another aspect of OBEX involves permission attributes of objects, e.g., files or folders, where the OBEX specification, version 1.3 and the related OBEX Errata of April 2003 define how object access permission attributes are presented and handled. More particularly, a remote OBEX client can remotely modify the attributes via an OBEX connection, as well as query such attributes by requesting a folder-listing of a specified folder. Once the folder-listing is received by the OBEX client, any information comprising file attributes of all the files associated with the specified folder can be identified.

For example, a file attribute or property can refer to that information which refers to and/or describes certain aspects of the file, e.g., whether or not the file is write-protected. As described above, conventional methods of retrieving attributes involve scanning a folder's properties. In addition, the actual file, in certain instances, for example, when the actual file is not read protected, can be downloaded to gain access to the file's header, which contains the file's attributes therein.

In cases where the file is read protected, the response (e.g., Forbidden 0x43(0xC3)) to such a GET should also contain a Permission header so that a requester can see the READ attribute (e.g., R=0), file is read protected.

However, either method requires a certain amount of system overhead for transferring data and for searching for the desired data. That is, the requesting of long folder-listing objects and parsing each one for a single, specific entry can involve a significant amount of time, where the loss of this time can interfere with the usability of object, an application that utilizes the object, etc.

The OBEX Errata of April 2003 generally mentions that “Permission” headers (i.e., transporting object attributes) can be used with GET operations. FIG. 1 illustrates a message flow associated with a conventional GET request and SUCCESS response. An OBEX client 100 and an OBEX server 110 engage in a GET operation, requesting that the OBEX server 110 return an object to the OBEX client 100. The GET request can be sent from the OBEX client 100 to the OBEX server 110, where the GET request, for example, contains a Name header and other OBEX headers, but not a Permissions header. It should be noted that FIG. 1 shows the final GET request, indicating that the relevant packet is the last packet containing headers that describe the object between requested. In response, the OBEX server 110 transmits a SUCCESS response. In this case, it can be assumed that the entire requested object could fit in one response packet, hence a final SUCCESS response is transmitted, where the response can include OBEX headers followed by the object body with data.

It should be noted that Permissions comprise a 4-byte unsigned integer, where the 4 bytes describe bit masks that represent various permissions values, e.g., setting “Read,” “Write,” “Delete,” and “Modify Permissions” permissions for files and folders. The Permissions header can be utilized with different operations, e.g., COPY, MOVE/RENAME, and SET_PERMISSIONS, including the GET operation described above.

Despite the ability to provide permissions attributes upon, for example, the scanning of an entire folder's properties through the use of a GET request, neither the OBEX specification nor the OBEX Errata specification describe how an OBEX client can query the attribute(s) of only one specific object. Furthermore, permission attribute handling as described in the OBEX Errata specification has not gained conventional acceptance in terms of use in connectivity devices, and the lack of detail with regard to the handling of Permission headers will likely result in implementations that produce interoperability issues between OBEX devices. In other words, support of Permission headers as defined in the OBEX Errata is optional, resulting in a good chance that OBEX clients will not understand and confuse such received information.

### SUMMARY

Various embodiments provide systems and methods that can be utilized to view the properties/attributes of a selected or specified object in the OBEX environment. A field, e.g., a Permissions header field, is included in a GET request, where the Permissions header is set to some arbitrary value such as, for example, headerID,0,0,0. In responding to the GET request from an OBEX client, the OBEX server includes one or more permissions associated with an object specified in the GET request in a response, where the one or more associated permissions are included before actual body data. Therefore, the OBEX client may efficiently and directly query an object's attributes in accordance with the OBEX specification. Additionally, if the OBEX client is not interested in the body data of the object, the GET operation can be aborted upon receiving the desired Permission header. It should be noted that there is no version string defined in OBEX, nor any other mechanism for indicating which subset of optional OBEX protocol features that a device supports. Therefore, by sending a Permission header, e.g., a Permission header having some arbitrary value set, such as headerID,0,0,0, in the GET request, the OBEX client in effect, signals that it is able to understand Permission header information. This effectively informs the OBEX server that a response therefrom, which includes Permission header information, will be understood.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a messaging flow diagram representative of a conventional OBEX GET operation;

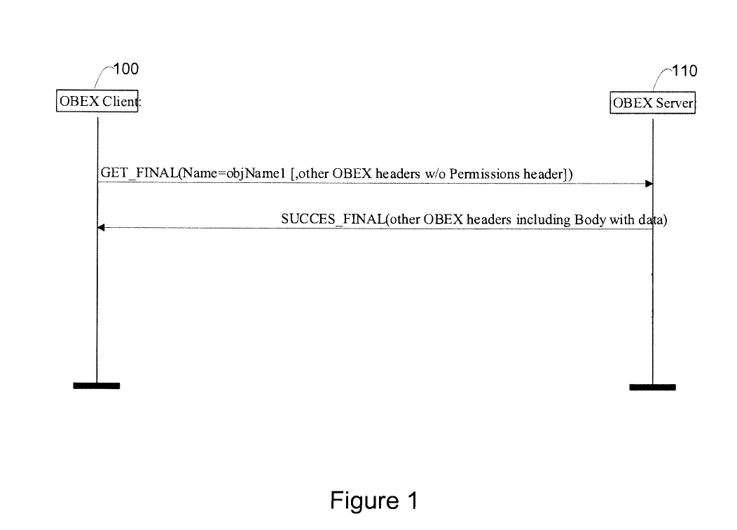

FIG. 2 is a messaging flow diagram representative of an OBEX GET operation effectuated in accordance with one embodiment;

FIG. 3 is a messaging flow diagram representative of an OBEX GET operation effectuated in accordance with another embodiment;

FIG. 4 is a messaging flow diagram representative of an OBEX GET operation effectuated in accordance with yet another embodiment;

FIG. 5 shows a flow chart describing various operations performed in accordance with various embodiments;

FIG. 6 is an overview diagram of a system within which the present invention may be implemented;

FIG. 7 is a perspective view of a mobile telephone that can be used in the implementation of the present invention; and

FIG. 8 is a schematic representation of the telephone circuitry of the mobile telephone of FIG. 7;

### DETAILED DESCRIPTION OF VARIOUS EMBODIMENTS

Various embodiments described in greater detail below provide systems and methods that can be utilized, for example, in OBEX folder browsing applications, to view the properties/attributes of a selected or specified object. A field, e.g., a Permissions field, is included in a GET request, where the field includes a header portion, e.g., a Permission header having some arbitrary value set, such as headerID,0,0,0. It should be noted that a Permissions header has a fixed length, e.g., 4 bytes. It should also be noted that a Permissions header value set to headerID, 0, 0, 0, indicates that the first byte contains a header ID and the remaining bytes are set to zero.

As described above, the OBEX protocol can operate within a client-server architecture. OBEX clients and servers can be, for example, devices or network elements/nodes that are communicatively connected to each other, and which can send, receive, and respond to requests. For example an OBEX client is an entity that can initiate an underlying transport connection to an OBEX server and can initiate OBEX operations. The OBEX server is an entity that can respond to OBEX operations upon, for example, initiation of the underlying transport connection by the OBEX client.

In responding to the GET request from an OBEX client, the OBEX server includes one or more permissions associated with an object specified in the GET request in a response, where the one or more associated permissions are included before actual body data. It should be noted that the various embodiments operate in accordance with the OBEX specification, thus allowing new and “older” OBEX devices to request and retrieve the desired properties/attributes without confusion. Moreover, there is no version string defined in OBEX, nor any other mechanism for indicating which subset of optional OBEX protocol features that a device supports. Therefore, by sending the arbitrarily valued Permission header in the GET request, the OBEX client in effect, signals that it is able to understand Permission header information. This effectively informs the OBEX server that a response therefrom, which includes Permission header information, will be understood.

It should be noted that a GET request can be formatted with a code included in a first byte indicating the type of request, e.g., a GET request, a packet length included in the second and third bytes, and a sequence of headers included in the remaining bytes. The included headers can include allowable headers that are specified in the OBEX specification, such as a Name header, a Time header, a Connection ID header, a Body header, etc. It should also be noted that a final bit is used in a GET request to signify the last packet containing headers describing the specified object that has been requested and that the request phase of the GET operation is complete. Therefore, once a GET message is sent with the final bit, all subsequent GET request packets set the final bit until the operation is complete. Hence, in terms of the Permission header, the OBEX server can respond to the first final GET request. Alternatively, if the OBEX client is not interested in the body data, but is only interested in the Permission header, the already received body data can either be ignored, or a subsequent ABORT request can be sent to the OBEX server.

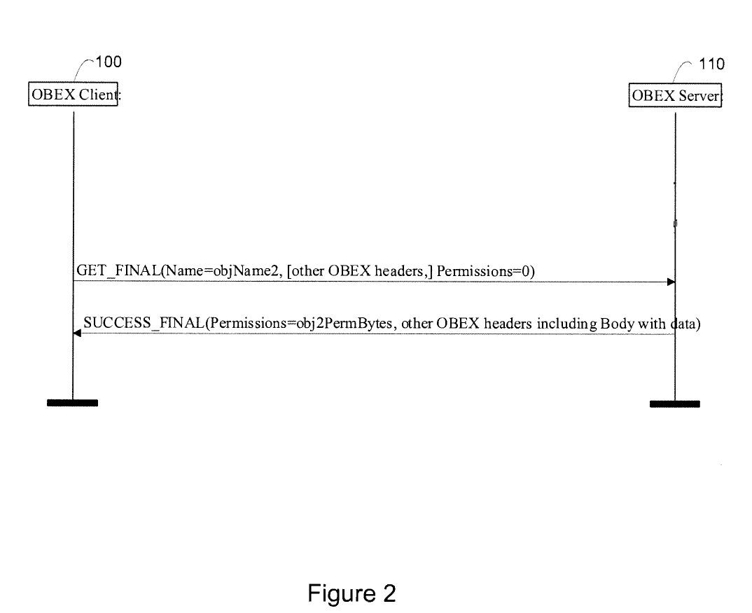

FIG. 2 shows a GET operation executed in accordance with one embodiment. As described above, multi-step GET operations can be effectuated. However, the Permission header is sent with the final GET request. Therefore, referring to FIG. 2, the OBEX client 100 transmits a final GET request to the OBEX server 110. The final GET request can include a Name header, other object headers as discussed above, and a Permission field. If a SUCCESS response to the GET request for the object can be fit into a single response packet, the OBEX server 110 responds to the OBEX client 100 with a final SUCCESS response that includes one or more permissions associated with the requested object, other relevant OBEX headers, and body with data. Because the response is a final SUCCESS response, the final bit is set in the response code. It should be noted that the SUCCESS response can be formatted to include a response code in the first byte, a response length packet in the second and third bytes, and any optional response headers in the remaining bytes, e.g., body headers. It should also be noted that the response can comprise a “fail” response, where instead of a SUCCESS response, a FORBIDDEN response is sent to the OBEX client 100.

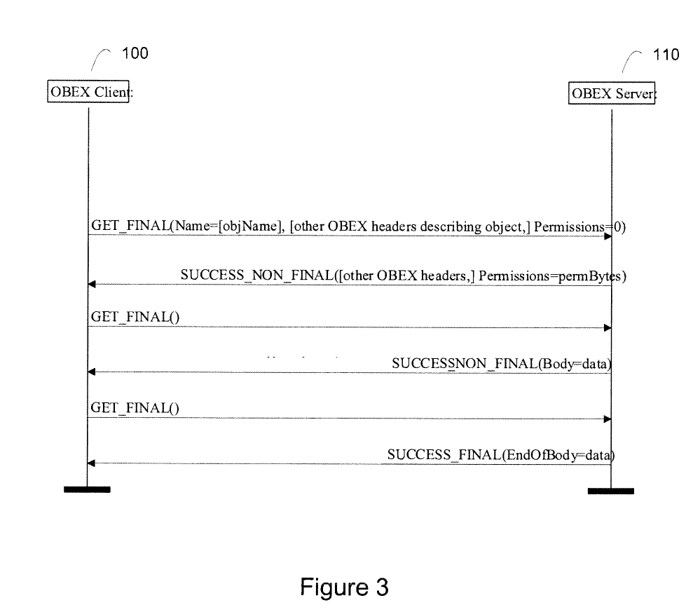

FIG. 3 illustrates a message flow effectuated in accordance with another embodiment, where multiple final GET requests are sent. The OBEX client 100 sends a first, final GET request to the OBEX server 110, where the final GET request includes a Name header, other OBEX headers that describe the object, and a Permission field, a Permission header having some arbitrary value set, such as headerID,0,0,0. As described above, a Permissions header has a fixed length, e.g., 4 bytes, where a Permissions header value set to headerID, 0, 0, 0, indicates that the first byte contains a header ID and the remaining bytes are set to zero. In response to the first, final GET request, the OBEX server 110 sends a non-final SUCCESS response message to the OBEX client 100 including the other OBEX headers and one or more Permission headers. This process can be repeated as many times as is necessary to transmit the object and its associated data until the OBEX server 110 responds with a final SUCCESS message that includes an End-of-Body header along with a SUCCESS response code. It should be noted that as mentioned above the first byte of a response message contains a response code. In this scenario, when the OBEX server 110 has not sent the End-of-Body header yet, the response code of the response message can be a CONTINUE response code.

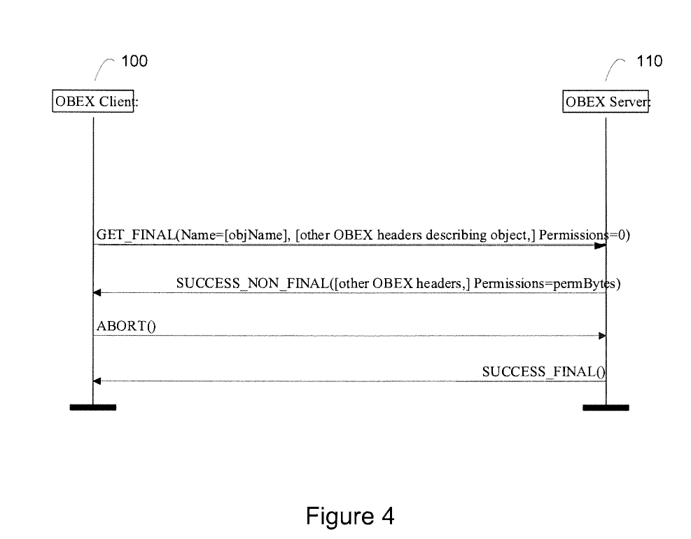

FIG. 4 shows a message flow in accordance with yet another embodiment, where the OBEX client aborts the GET operation upon receiving the desired permissions. In this scenario, the OBEX client, as before, transmits a final GET request message to the OBEX server 110, where the message includes a Name header, other headers associated with the requested object, and a Permission field, e.g., a Permission header having some arbitrary value set, such as headerID,0,0,0. When the OBEX server 110 responds to the OBEX client 100 with a non-final SUCCESS message including at least the desired permissions, the OBEX client returns an ABORT message. Therefore, if the OBEX client 100 is only concerned with permission data, time and resources are not wasted by transmitting the entire object and any related data thereto. Upon receiving the ABORT message, the OBEX server 110 can respond with a final SUCCESS message to the OBEX client 100. It should also be noted that the response can comprise a “fail” response, where instead of a SUCCESS response, a FORBIDDEN response is sent to the OBEX client 100.

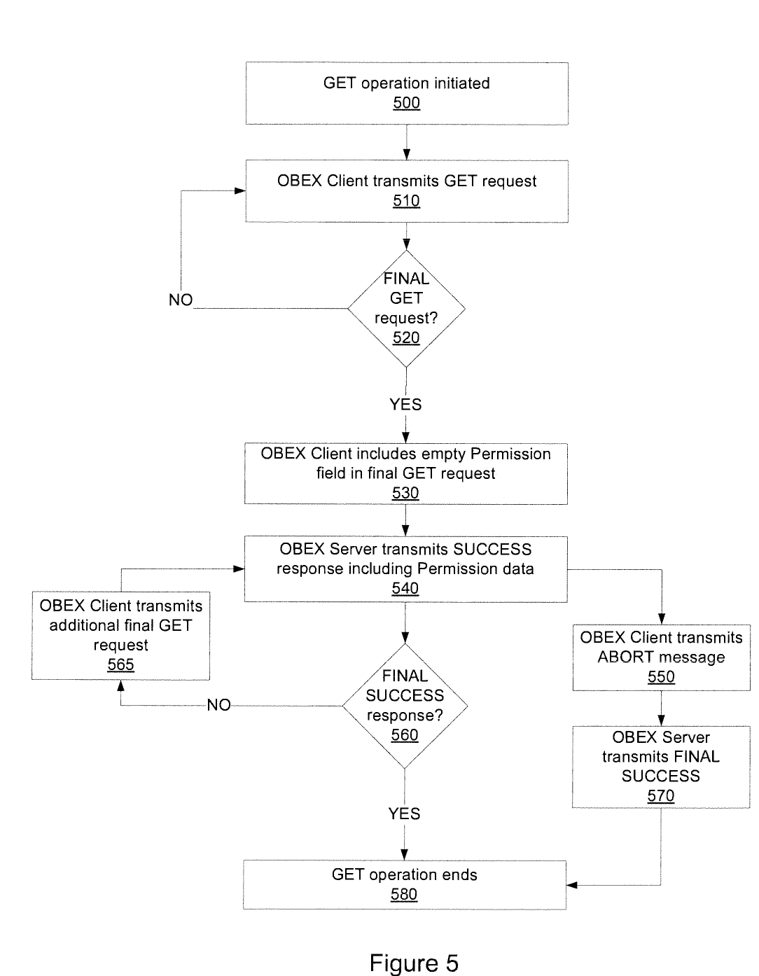

FIG. 5 illustrates a flow chart of operations performed in accordance with various embodiments. At 500, a GET operation is initiated and at 510, an OBEX client transmits a GET request to an OBEX server. As described above, multi-step GET operations can be effectuated in accordance with various embodiments. Therefore, at 520, it is determined whether or not the GET request transmitted from the OBEX client is final, a final GET request identifying the last packet containing headers describing the object that is being requested. If the GET request is not final, additional GET request messages can be transmitted. If the GET request is to be final, the GET request message is transmitted with a Permission field at 530.

In response to a final GET request including a Permission field, the OBEX server transmits a SUCCESS response including the desired Permission header/data associated with the request object at 540. It should be noted that multiple final GET requests and responses may be necessary if the response is large enough, e.g., the object body data cannot fit into one response packet. If this is the case, after determining that a final SUCCESS response cannot yet be sent at 560, the OBEX client and the OBEX server trade additional final GET requests and non-final SUCCESS responses at 565 and 540. When the final SUCCESS response is transmitted from the OBEX server to the OBEX client, the GET operation is completed at 580. Alternatively, upon the OBEX client receiving the desired object attribute(s), e.g., the Permission header, the OBEX client can transmit an ABORT message to the OBEX server at 550. Upon receiving the ABORT message, the OBEX server can transmit a final SUCCESS response to the OBEX client at 570. Thereafter, the GET operation is completed at 580. As noted above, the response can comprise a “fail” response, where instead of a SUCCESS response, a FORBIDDEN response is sent to the OBEX client.

The OBEX protocol has been described herein and exemplary embodiments have been described in relation to the OBEX protocol. However, it should be noted that various embodiments of the present invention can be implemented/utilized with other protocols designed for exchanging objects over a bidirectional data link, e.g., protocols for exchanging music files, images, video, sound, programs. etc.

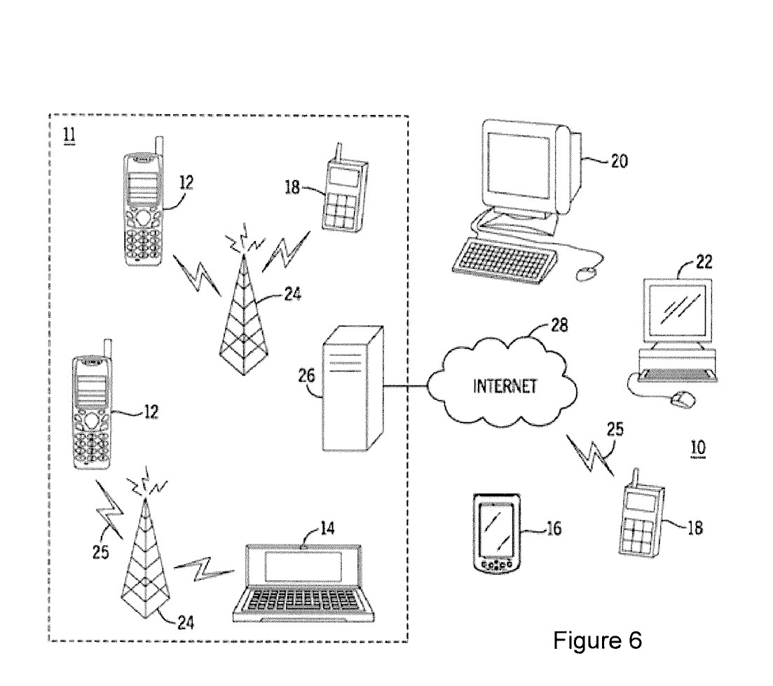

FIG. 6 shows a system 10 in which the present invention can be utilized, comprising multiple communication devices that can communicate through a network. The system 10 may comprise any combination of wired or wireless networks including, but not limited to, a mobile telephone network, a wireless Local Area Network (LAN), a Bluetooth personal area network, an Ethernet LAN, a token ring LAN, a wide area network, the Internet, etc. The system 10 may include both wired and wireless communication devices.

For exemplification, the system 10 shown in FIG. 6 includes a mobile telephone network 11 and the Internet 28. Connectivity to the Internet 28 may include, but is not limited to, long range wireless connections, short range wireless connections, and various wired connections including, but not limited to, telephone lines, cable lines, power lines, and the like.

The exemplary communication devices of the system 10 may include, but are not limited to, a mobile device 12, a combination PDA and mobile telephone 14, a PDA 16, an integrated messaging device (IMD) 18, a desktop computer 20, and a notebook computer 22. Such devices can be utilize OBEX to exchange binary data as described above. The communication devices may be stationary or mobile as when carried by an individual who is moving. The communication devices may also be located in a mode of transportation including, but not limited to, an automobile, a truck, a taxi, a bus, a boat, an airplane, a bicycle, a motorcycle, etc. Some or all of the communication devices may send and receive calls and messages and communicate with service providers through a wireless connection 25 to a base station 24. The base station 24 may be connected to a network server 26 that allows communication between the mobile telephone network 11 and the Internet 28. The system 10 may include additional communication devices and communication devices of different types.

The communication devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device may communicate using various media including, but not limited to, radio, infrared, laser, cable connection, and the like.

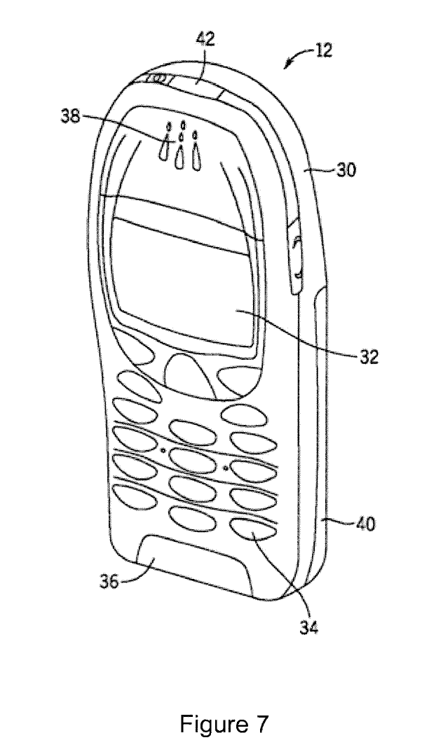

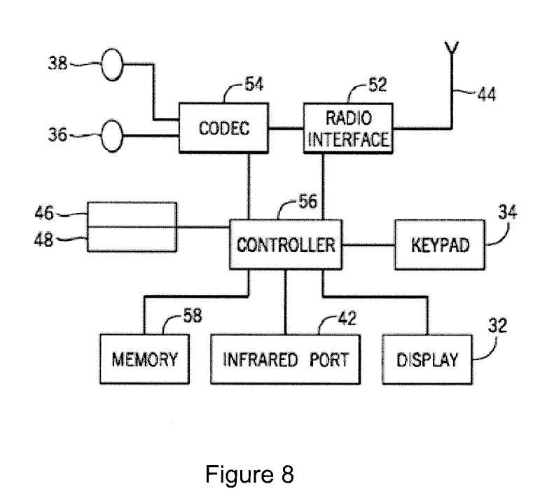

FIGS. 7 and 8 show one representative mobile device 12 within which the present invention may be implemented. It should be understood, however, that the present invention is not intended to be limited to one particular type of electronic device. The mobile device 12 of FIGS. 7 and 8 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, codec circuitry 54, a controller 56 and a memory 58. Individual circuits and elements are all of a type well known in the art, for example in the Nokia range of mobile telephones.

The present invention is described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module,” as used herein and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method, comprising:
transmitting a request for a protocol object, the request including an attribute field; and
receiving a response to the request, the response containing at least one attribute associated with the protocol object.

2. The method of claim 1, wherein the protocol object comprises one of a single file and a single folder.

3. The method of claim 1, wherein the attribute field comprises a permissions header and the at least one attribute is contained in the permissions header.

4. The method of claim 1, wherein the request comprises an object exchange protocol GET request and the response comprises an object exchange protocol response.

5. The method of claim 4 further comprising, transmitting an abort message to prevent receipt of further data associated with the protocol object.

6. A computer program product, embodied on a computer-readable medium, configured to perform the processes of claim 1.

7. An apparatus, comprising:
a processor; and
a memory unit communicatively connected to the processor and including:
computer code configured to transmit a request for a protocol object, the request including an attribute field; and
computer code configured to receive a response to the request, the response containing at least one attribute associated with the protocol object.

8. The apparatus of claim 7, wherein the protocol object comprises one of a single file and a single folder.

9. The apparatus of claim 7, wherein the attribute field comprises a permissions header and the at least one attribute is contained in the permissions header.

10. The method of claim 7, wherein the request comprises an object exchange protocol GET request and the response comprises an object exchange protocol response.

11. The apparatus of claim 10 further comprising, transmitting an abort message to prevent receipt of further data associated with the protocol object.

12. A method, comprising:
receiving a request for a protocol object, the request including a attribute field; and
transmitting a response to the request, the response containing at least one attribute associated with the protocol object.

13. The method of claim 12, wherein the protocol object comprises one of a single file and a single folder.

14. The method of claim 12, wherein the attribute field comprises a permissions header and the at least one attribute is contained in the permissions header.

15. The method of claim 12, wherein the request comprises an object exchange protocol GET request and the response comprises an object exchange protocol response.

16. The method of claim 15 further comprising, receiving an abort message to prevent transmission of further data associated with the protocol object.

17. A computer program product, embodied on a computer-readable medium, configured to perform the processes of claim 12.

18. An apparatus, comprising:
a processor; and
a memory unit communicatively connected to the processor and including:
computer code configured to receive a request for a protocol object, the request including an attribute field; and
computer code configured to transmit a response to the request, the response containing at least one attribute associated with the protocol object.

19. The apparatus of claim 18, wherein the protocol object comprises one of a single file and a single folder.

20. The apparatus of claim 18, wherein the attribute field comprises a permissions header and the at least one attribute is contained in the permissions header.

21. The apparatus of claim 18, wherein the request comprises an object exchange protocol GET request and the response comprises an object exchange protocol SUCCESS response.

22. The apparatus of claim 21 further comprising, receiving an abort message to prevent transmission of further data associated with the protocol object.

23. A system, comprising:
a client configured to transmit a protocol request message for an object, the protocol request including at least a permission header field; and
a server configured to receive the protocol request message and respond to the protocol request message by transmitting a response to the client, the response including at least one attribute associated with the object contained in a permission header.

24. The system of claim 23, wherein the object comprises one of a single object exchange protocol file and a single object exchange protocol folder.

25. The system of claim 23, wherein upon a determination that the client no longer wishes to receive further data associated with the object, the client is configured to transmit an abort message to the server.

26. As system, comprising:
client means for transmitting a protocol request message for an object, the protocol request including at least a permission header field; and
server means configured to receive the protocol request message and respond to the protocol request message by transmitting a response to the client, the response including at least one attribute associated with the object contained in a permission header.

27. The system of claim 26, wherein the object comprises one of a single object exchange protocol file and a single object exchange protocol folder.

28. The system of claim 26, wherein upon a determination that the client means no longer wishes to receive further data associated with the object, the client means transmits an abort message to the server means.
